(19) United States
(12) Patent Application Publication
(10) Pub. No.: US 2025/0301346 A1
(43) Pub. Date: Sep. 25, 2025

(54) CORE NETWORK VISIBLE QUALITY OF EXPERIENCE (QOE) MEASUREMENTS

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US); Mukesh Kumar MITTAL, San Diego, CA (US); Manish TRIPATHI, San Diego, CA (US)

(21) Appl. No.: 18/975,919

(22) Filed: Dec. 10, 2024

Related U.S. Application Data
(60) Provisional application No. 63/568,733, filed on Mar. 22, 2024.

(51) Int. Cl. H04W 24/08

(52) U.S. Cl. CPC H04W 24/08

(57) ABSTRACT

Certain aspects of the present disclosure provide a method for wireless communications at a user equipment (UE). The UE may transmit capability information of the UE to a gNodeB (gNB). The capability information may indicate an ability of the UE to directly transmit quality of experience (QoE) measurements to a core network entity. The UE may measure and transmit first QoE measurements to the core network entity, in accordance with the capability information. The core network entity may determine and perform some actions (e.g., an update of quality of service (QOS) policy associated with the UE) based on the first QoE measurements.

### CROSS-REFERENCE TO RELATED APPLICATION

This application claims benefit of and priority to U.S. Provisional Patent Application No. 63/568,733, filed Mar. 22, 2024, which is hereby incorporated by reference in its entirety.

### BACKGROUND

### Field of the Disclosure

Aspects of the present disclosure relate to wireless communications, and more particularly, to techniques for managing quality of experience (QoE) measurements.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting capability information indicating an ability of the UE to report quality of experience (QoE) measurements associated with the UE to a core network entity. The method further includes transmitting first QoE measurements associated with the UE to the core network entity, in accordance with the capability information.

Another aspect provides a method for wireless communications at a core network entity. The method includes receiving capability information of a UE indicating an ability of the UE to report QoE measurements associated with the UE to the core network entity. The method further includes receiving first QoE measurements associated with the UE, in accordance with the capability information of the UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 depicts a call flow diagram illustrating example communication among a UE, network entities, and other devices for a quality of experience (QoE) measurement collection (QMC).

FIG. 6 depicts a call flow diagram illustrating example communication among a central unit (CU) and a distributed unit (DU) of a gNodeB (gNB).

FIG. 7 depicts a call flow diagram illustrating example communication among different wireless nodes for managing QoE measurements.

FIG. 8 depicts a method for wireless communications at a wireless node such as a UE.

FIG. 9 depicts a method for wireless communications at a wireless node such as a core network entity.

FIG. 10 and FIG. 11 depict example communications devices.

### DETAILED DESCRIPTION

Aspects of the present disclosure provide apparatuses, methods, processing systems, and computer-readable mediums for managing quality of experience (QoE) measurements.

A primary motivation for development of communication technologies is to provide efficient and reliable communication, in order to improve user experience. So, an evaluation of the user experience for various services being used at a user equipment (UE) may be considered vital to network operators. This may be especially important when the network operators provide high bit rate real-time services like streaming services (e.g., video streaming services), where even an intermittent quality degradation is bothersome for a user of the UE. Since many of the streaming services represent a significant part of a commercial traffic growth rate, providers may put a heightened focus on the user experience.

Quality of experience (QoE) refers to a measure of an overall level of user's satisfaction and experience with applications and services (e.g., such as the streaming services) used at the UE. International Telecommunication Union (ITU) defines the QoE as “the overall acceptability of an application or service, as perceived subjectively by the end-user.”

The QoE of using the streaming services at the UE is dependent on an end-to-end process (e.g., which may include different operations performed at the UE, a radio access network (RAN) node, a core network node which may manage or control the RAN node). Presently, the UE may calculate QoE measurements (e.g., playout delay measurements for the streaming services) and send the QoE measurements to the RAN node. The QoE measurements may be good QoE measurements (e.g., when QoE expectations are being met) or bad QoE measurements (e.g., when the QoE expectations are not being met). In some cases, the bad QoE measurements may be due to some problems (or issues) associated with the RAN node or the core network node. When the bad QoE measurements are due to some problems associated with the core network node, then there is a need for the UE to transmit the bad QoE measurements to the core network node (e.g., as opposed to the RAN node), so that the core network node may perform some actions to prevent degradation of the QoE or improve the QoE.

Techniques described herein may configure and enable the UE to transmit the QoE measurements to the core network node, along with an indication that the QoE measurements (e.g., such as the bad QoE measurements) are due to some problems associated with the core network node and not the RAN node. The UE may also notify the core network node information associated with the problems (e.g., such as a current quality of service (QOS) policy associated with the UE, a current transport network bandwidth, a current latency value, etc.) and how these problems can be resolved. Based on information received from the UE, the core network node may determine and execute one or more actions to solve the indicated problems and improve the QoE.

Particular aspects of the subject matter described in this disclosure can be implemented to realize one or more of the following potential advantages. In some examples, the described techniques may allow an access and mobility management function (AMF), which is one of control plane network functions of the core network node to modify the current QoS policy associated with the UE, adjust a current value of the transport network bandwidth and/or adjust a current value of the latency, based on processing of the received QoE measurements to improve the QoE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

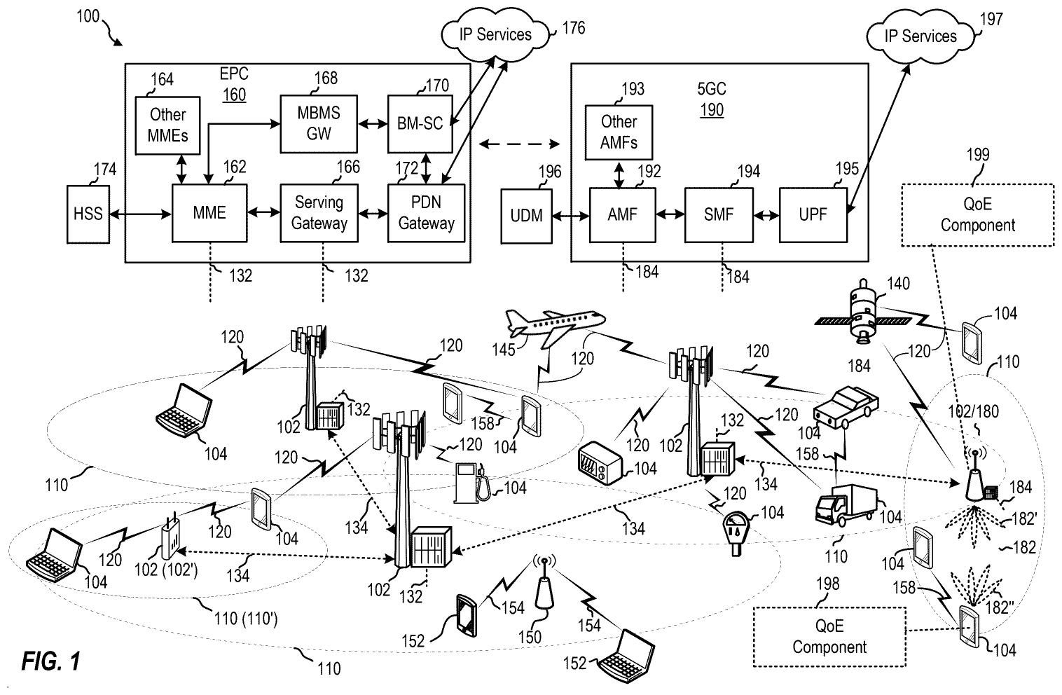

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

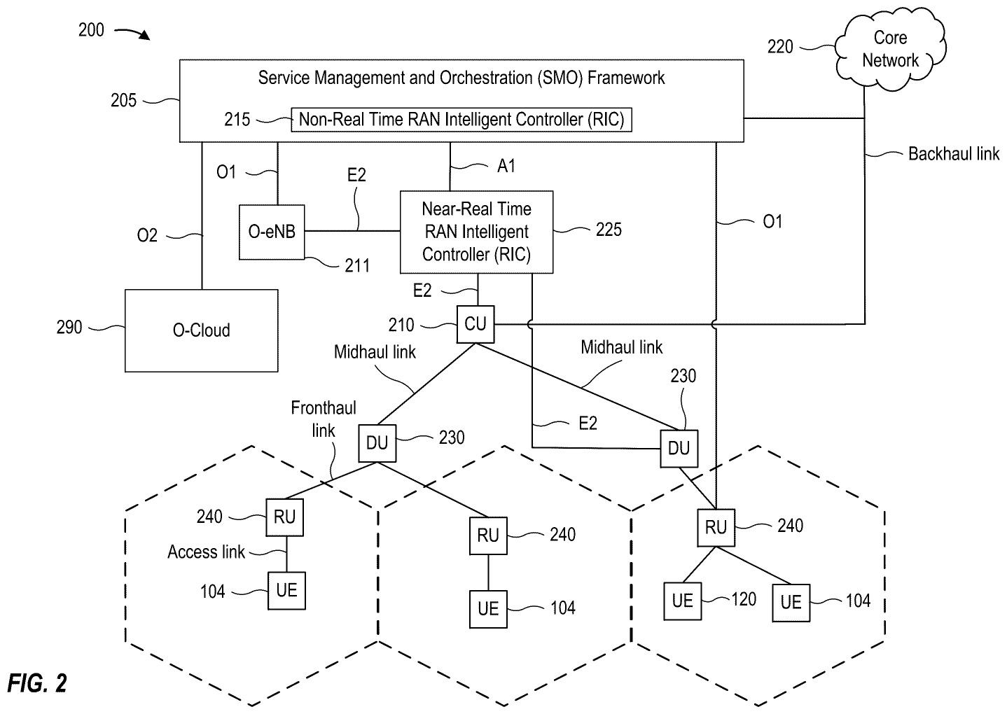

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

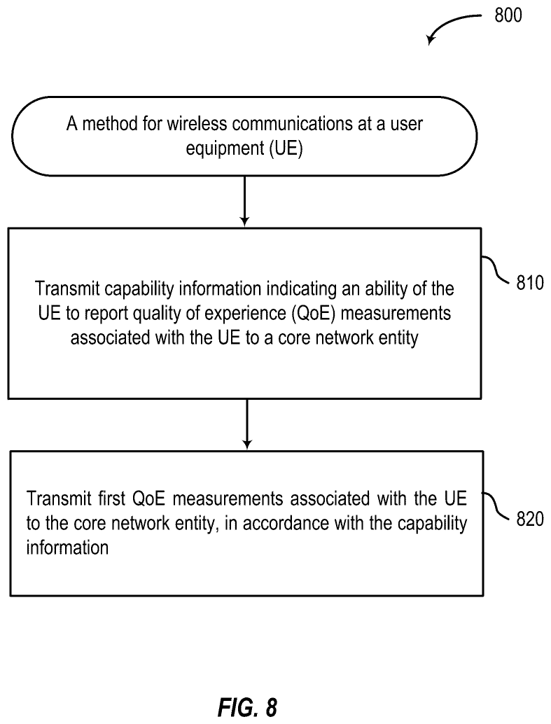

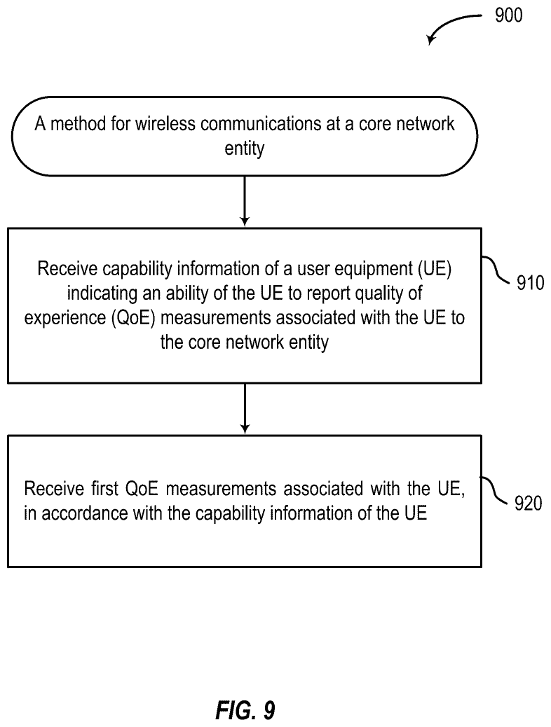

Wireless communication network 100 further includes quality of experience (QoE) component 198, which may be configured to perform method 800 of FIG. 8. Wireless communication network 100 further includes QoE component 199, which may be configured to perform method 900 of FIG. 9.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

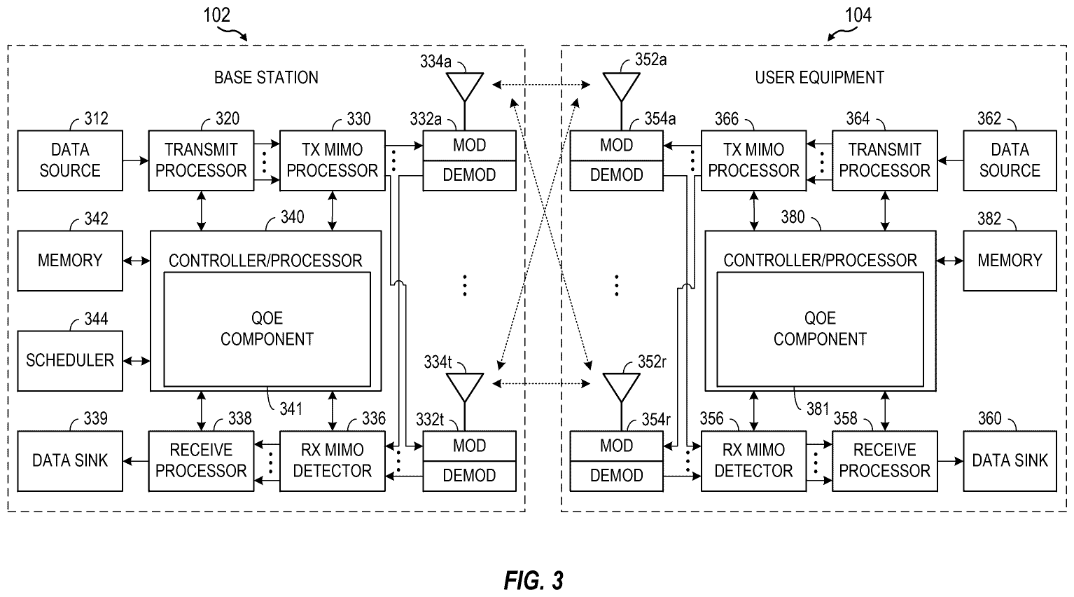

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes QoE component 341, which may be representative of QoE component 199 of FIG. 1. Notably, while depicted as an aspect of controller/processor 340, QoE component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes QoE component 381, which may be representative of QoE component 138 of FIG. 1. Notably, while depicted as an aspect of controller/processor 380, QoE component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

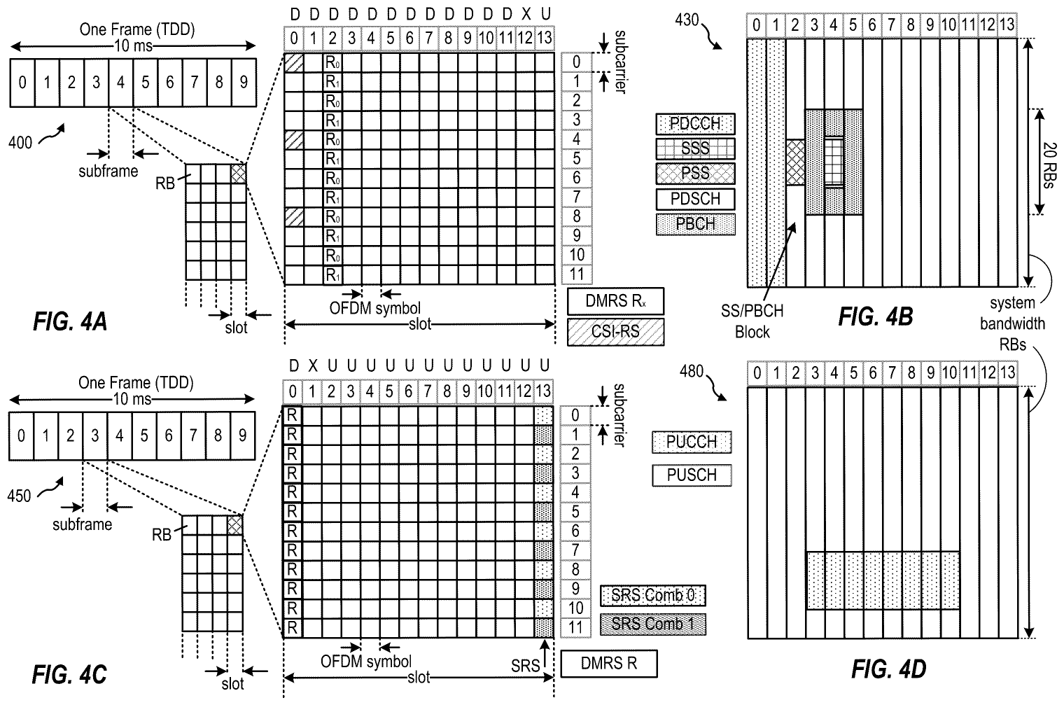

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 US.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Introduction to mm Wave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FRI is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Quality of Service (QOS)

Quality of service (QOS) refers to a measurement of an overall performance of a service experienced by users of a network. To quantitatively measure the QoS, a packet loss, a bit rate, a throughput, a transmission delay, an availability, a jitter, and other related aspects of the service are considered.

In some cases, the QoS may be defined as an ability to provide different priority to different applications, users, or data flows, or to guarantee a certain level of performance to a data flow. In some cases, the QoS may be defined as a control mechanism to provide a high quality communication over a best-effort network by over-provisioning a capacity so that it is sufficient for an expected peak traffic load. In some cases, the QoS may refer to a level of a quality of service, i.e., a guaranteed service quality.

In new radio (NR), QoS architecture may be based on QoS flows. A QoS flow may be a finest granularity of QoS differentiation in a protocol data unit (PDU) session. Each QoS flow may be identified by a unique identifier called a QoS flow ID (QFI). The QFI is unique with in a PDU session.

In some cases, multiple QoS flows may be mapped on a same data radio bearer (DRB). The PDU session can transfer more than one QoS flow which are mapped on to a DRB in an access network and all packets belonging to same PDU session with the same QFI are prioritized equally, i.e. receive same packet forwarding treatment.

NR architecture handles multiple categories of the QoS flows such as a guaranteed bit rate (GBR) QoS flow (e.g., which provides a guaranteed flow bit rate to an end user, and is used for time critical applications), a non-guaranteed bit rate (non-GBR) QoS flow (e.g., which does not require a guaranteed flow bit rate, and is used for non-time sensitive applications), and a delay critical guaranteed bit rate (GBR) QOS flow (e.g., which provides latencies significantly lower than guaranteed flow bit rate, and used in mission critical application like automation or intelligent transportation systems).

In some cases, the QFI may be carried in an encapsulation header on N3 interface. Every QoS flow may be characterized by a QoS profile provided by 5^{th} generation core (5GC) network. QoS rules may be provided by a session management function (SMF) to a user equipment (UE) via an access and mobility management function (AMF) where uplink UE traffic is mapped to the QoS flows based on the QoS rules.

### Overview of Quality of Experience (QoE)

Quality of experience (QoE) may be a measure of an overall level of a customer's satisfaction and experience with a product or service and a vendor that is providing that product or service. International Telecommunication Union (ITU) defines QoE as “the overall acceptability of an application or service, as perceived subjectively by the end-user.” The QoE may be a measure used to help understand the individual experiences of actual users when the users interact with an application or service. Accordingly, the QoE takes viewpoint of the users while assessing the quality of a product or service. Most importantly, the QoE aims to answer the question, “did this product or service deliver a sufficient or good experience to end users, and to what extent?”

The QoE and a quality of service (QOS) are two distinct but interrelated concepts that play crucial roles in a delivery of services (e.g., video streaming services). For example, the QoE revolves around user satisfaction and perception, while the QoS focuses on technical aspects of content delivery. Balancing both the QoE and the QoS effectively is essential for providers to offer a best possible experience.

When delivering a product or service, many factors can affect customer experiences and the resulting QoE including cost, reliability, efficiency, scalability, speed, accuracy, privacy, and/or usability.

For new radio (NR)-related products or services, factors such as an available bandwidth, a jitter, a delay and/or a packet loss rate may affect customer satisfaction and the QoE. Examples of NR services may include cloud computing, telecommunications, video streaming, and/or multimedia applications.

### Overview of QoE Measurement Collection (QMC)

New radio (NR) networks provide a high throughput and a low delay, which may contribute to enhanced quality of experience (QoE) expectations. A QoE is a measure of user's experiences with a service (e.g., web browsing, video streaming, etc.). The QoE considers a user's expectation, while a quality of service (QOS) is based on technical measurements.

As a measure of an end-to-end performance at a service level from the user's perspective, the QoE is a significant metric used for a design of systems and engineering processes. This is particularly relevant for video services because due to their high traffic demands, bad network performance may highly affect the user's experience. QoE metrics are often measured at a user equipment (UE).

A QoE measurement collection (QMC) may enable collection of application layer measurements (e.g., QoE measurements) for different service types from the UE. The QMC may be handled by an application layer of the UE. Currently, there are configuration, activation, and/or deactivation procedures for both signaling-based and management-based QMC and reporting. For example, according to some procedures, a QoE measurement configuration and report may be transmitted using radio resource control (RRC) messages between the UE and a next generation radio access network (NG-RAN) (e.g., gNodeB (gNB)). The QMC may be supported during an RRC connected state of the UE.

The QMC may support various services such as dynamic adaptive streaming over hypertext transfer protocol (HTTP) (DASH) services, multimedia telephony service for internet protocol (IP) multimedia subsystem (IMS) (MTSI) services, and/or virtual reality (VR) services.

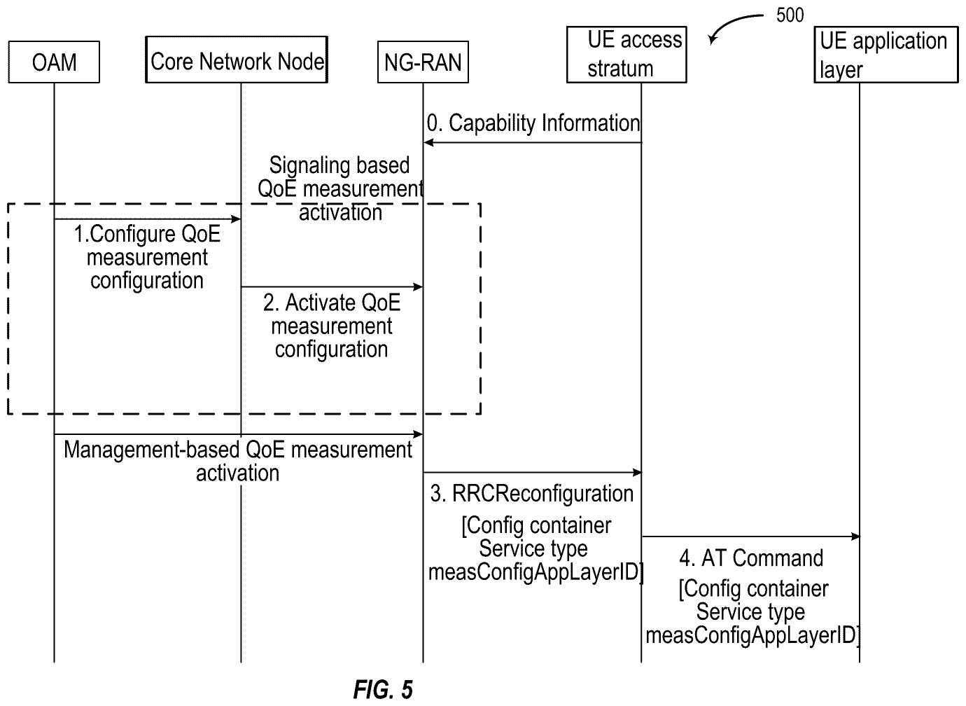

One or more procedures may be used to manage the QMC (e.g., configure, activate and/or deactivate the QoE measurement configuration). For example, FIG. 5 shows a diagram 500 illustrating QoE measurement configuration activation procedure. As illustrated in FIG. 5, an access stratum in a UE sends capability information of the UE to a NG-RAN node (e.g., which may be controlled or managed by a core network node (e.g., 5^{th} generation core (5GC))). The capability information may indicate that the UE can perform and transmit QoE measurements.

In a signaling-based QoE measurement configuration activation procedure, an operations and management (OAM) function may initiate a QoE measurement configuration activation for the UE via the core network node and the NG-RAN node. For example, the OAM function sends one or more QoE measurement configurations to the core network node, and the core network node forwards (to the UE) and activates the one or more QoE measurement configurations.

In a management-based QoE measurement configuration activation procedure, the OAM function sends the one or more QoE measurement configurations to the NG-RAN node.

The NG-RAN node receives the one or more QoE measurement configurations from the OAM function and/or the core network node. Each QoE measurement configuration may include a QMC configuration container/file (e.g., an extensible markup language (XML) file), a QoE reference, a service type, a magnetically controlled capsule endoscopy (MCE) internet protocol (IP) address, an area scope, a slice scope, minimization of drive test (MDT) alignment information, and/or available NG-RAN visible QoE metrics or measurements (e.g., which may be a subset of QoE measurements that are already configured as part of the QoE measurement configuration encapsulated in a transparent QMC configuration container).

The NG-RAN node sends the one or more QoE measurement configurations to the UE via an RRC message. The RRC message may be an RRC reconfiguration message. The RRC reconfiguration message may include the QMC configuration container, a QoE measurement configuration application layer ID, and/or the service type. A mapping between the QoE measurement configuration application layer ID and the QoE reference may be maintained at the NG-RAN node.

In some cases, the NG-RAN node may determine whether the UE has an application layer measurement capability (e.g., for performing the QoE measurements, based on the capability information provided by the UE) that may match a criteria for the service type indicated in the one or more QoE measurement configurations. When the NG-RAN node determines that the UE has the application layer measurement capability, the NG-RAN node may start a UE request session. The NR-RAN node may then send the RRC reconfiguration message to the UE.

The access stratum in the UE sends an ATtention (AT) command to an application layer of the UE. The AT command may include the QMC configuration container, the QoE measurement configuration application layer ID, and/or the service type. The application layer of the UE then initiates the QMC.

The application layer may send an AT command (e.g., including a recording session indication that a QMC session has started) to the access stratum in the UE. The access stratum in the UE may send a message including a measurement report (e.g., including the recording session indication) to the NG-RAN node. The NG-RAN node may send a notification (e.g., including the recording session indication) to the OAM function.

When the QMC is completed, recorded information (e.g., including the QoE measurements) is collected in a QMC report. The application layer may send an AT command including the QMC report to the access stratum in the UE. The access stratum in the UE may send the QMC report to the NG-RAN node. The NG-RAN node may send the QMC report to a MCE.

In some cases, the NG-RAN node may define the one or more QoE measurement configurations and/or configure NG-RAN visible QoE measurements (e.g., QoE measurements that can be and are reported to the NG-RAN), such that the UE may report at least a subset of all QoE measurements to the NG-RAN node. The NG-RAN node may use and/or process the subset of the QoE measurements to perform some actions for network optimization. The subset of the QoE measurements may include buffer level measurements, playout delay measurements, etc.

In some cases, the NG-RAN node may configure the UE to collect all or some of the available NG-RAN visible QoE measurements, where an indication of measurements availability is received from the OAM function or the core network node.

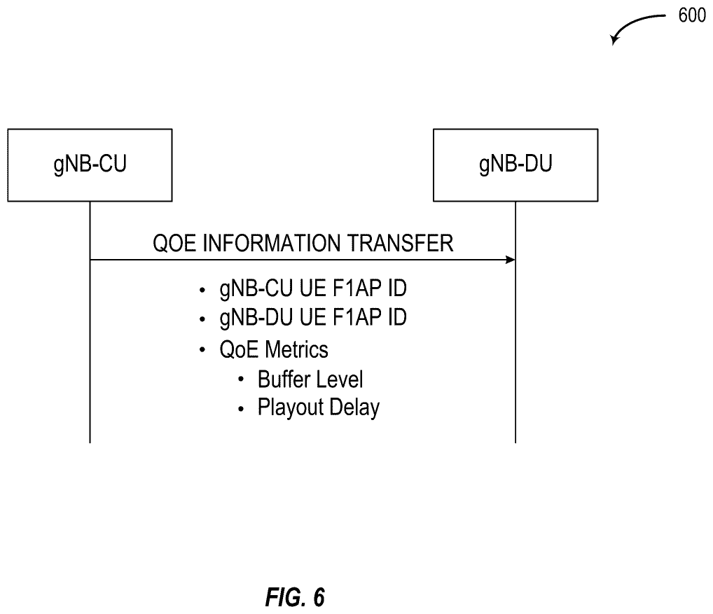

In some cases, as illustrated in a diagram 600 of FIG. 6, a message (e.g., a new class-2 message indicating a QoE information transfer) may be used to transfer the NG-RAN visible QoE measurements (e.g., such as the buffer level measurements and the playout delay measurements) from a central unit (CU) of a gNB (e.g., the NG-RAN) to a distributed unit (DU) of the gNB.

The QoE (e.g., of using video streaming services at the UE) is based on an end-to-end process (e.g., which may include different operations performed at the UE, the NG-RAN node, and the core network node). Presently, the UE may calculate the QoE measurements and send the QoE measurements to the NG-RAN node. The QoE measurements may be good QoE measurements (e.g., when the QoE expectations are being met) or bad QoE measurements (e.g., when the QoE expectations are not being met). The bad QoE measurements may be due to some problems (or issues) associated with the NG-RAN node or the core network node. When the bad QoE measurements are due to some problems associated with the core network node, then there is a need for the UE to transmit the bad QoE measurements to the core network node (e.g., as opposed to the NG-RAN node), so that the core network node may perform some actions to prevent degradation of the QoE or improve the QoE.

### Aspects Related to Core Network Entity Visible Quality of Experience (QoE) Measurements

Aspects of the present disclosure provide apparatuses, methods, processing systems, and computer-readable mediums for managing quality of experience (QoE) measurements.

For example, techniques described herein may configure and/or enable a user equipment (UE) to transmit the QoE measurements to a core network node, along with an indication that the QoE measurements (e.g., such as bad QoE measurements) are due to some problems associated with the core network node and not a radio access network (RAN) node. The UE may also notify information associated with the problems (e.g., such as a current quality of service (QOS) policy associated with the UE, a user plane function (UPF), a multi-access edge computing (MEC), a current transport network bandwidth, a current latency value, etc.) and how these problems can be resolved. The core network node may receive and process the QoE measurements and the information associated with the problems. Based on the processing of the QoE measurements and the information associated with the problems, the core network node may determine and execute one or more actions to solve the problems and improve the QoE.

Particular aspects of the subject matter described in this disclosure can be implemented to realize one or more of the following potential advantages. In some examples, the described techniques may allow an access and mobility management function (AMF), which is one of control plane network functions of the core network node to modify the current QoS policy associated with the UE, switch the UPF, adjust a current value of the transport network bandwidth and/or adjust a current value of the latency, based on processing of the received QoE measurements to improve the QoE.

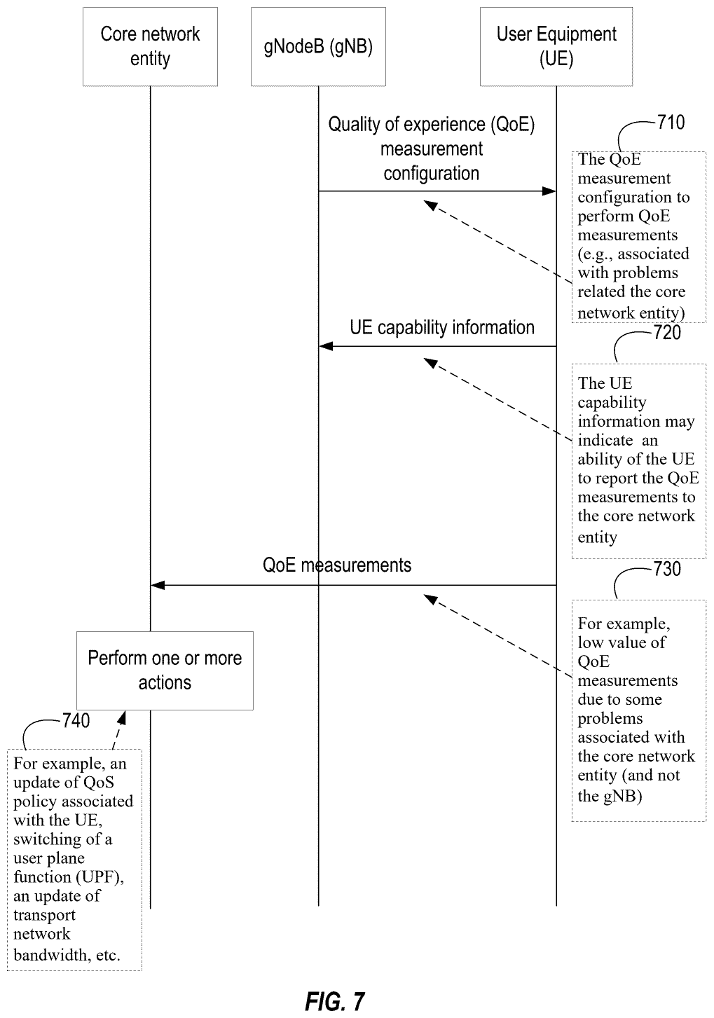

The techniques proposed herein for managing the QoE measurements may be understood with reference to FIG. 7-FIG. 11.

FIG. 7 depicts a call flow diagram 700 illustrating example communication among wireless nodes (e.g., a UE, a gNB, and a core network entity) for managing QoE measurements.

The UE shown in FIG. 7 may be an example of the UE 104 depicted and described with respect to FIG. 1 and FIG. 3. The gNB depicted in FIG. 7 may be an example of the BS 102 depicted and described with respect to FIG. 1 and FIG. 3, or the disaggregated BS depicted and described with respect to FIG. 2.

The core network entity depicted in FIG. 7 may be an example of the 5GC 190 of FIG. 1. The core network entity may be a heart of a new radio (NR) network, controlling data and control plane operations. The core network entity may aggregate data traffic, communicates with the UE, delivers essential network services and provides extra layers of security, among other functions. The core network entity may also be responsible for a variety of functions within a mobile network that makes communication possible. For example, authentication, authorization, and data and policy management are just a few services that run on the core network entity.

As indicated at 710, the gNB sends a QoE measurement configuration (e.g., for core network entity visible QoE measurements) to the UE. For example, the gNB may generate and then send the QoE measurement configuration to the UE.

In one aspect, the QoE measurement configuration may be a configuration configuring the UE to perform and/or transmit QoE measurements to the core network entity. The QoE measurements may indicate some problems related to the core network entity and/or the gNB.

In another aspect, the QoE measurement configuration may be a configuration configuring the UE to perform and/or transmit QoE measurements to the gNB.

In yet another aspect, the QoE measurement configuration may be a configuration configuring the UE to perform and/or transmit QoE measurements to the core network entity and the gNB.

In certain aspects, an AMF may configure the core network entity visible QoE measurements. For example, the AMF may define and transmit the QoE measurement configuration to the gNB. Per the QoE measurement configuration, the UE may have to report at least a subset of all QoE measurements (e.g., along with possible non-gNB related issues/problems associated with the QoE measurements) to the core network entity (e.g., that are readable by the core network entity).

As indicated at 720, the UE sends capability information (e.g., for core network entity visible QoE measurements) of the UE to the gNB via one or more messages (e.g., which may be radio resource control (RRC) messages). For example, the UE may define the capability information of the UE and then send the capability information to the gNB via the RRC messages.

In certain aspects, the capability information may indicate an ability of the UE to report (and/or transmit) the QoE measurements directly to the core network entity.

In certain aspects, the capability information may indicate the ability of the UE to report to the core network entity that one or more values of the QoE measurements are below a threshold (e.g., which may indicate bad or low QoE measurements) and the bad QoE measurements may be caused due to a source other than the gNB (e.g., due to the core network entity). In one example, the threshold may be defined by the UE. In another example, the threshold may be defined by the gNB and indicated to the UE.

In certain aspects, the capability information may indicate the ability of the UE to determine and/or report to the core network entity one or more problems (e.g., associated with the core network entity) that may have caused the one or more values of the QoE measurements to be below the threshold. For example, the problem may be based on a QoS policy associated with the UE. The QoS policy may define a certain level of performance.

In another example, the problem may be based on a UPF, which is a data plane in the core network entity and is associated with a data transfer process.

In another example, the problem may be based on a transport network bandwidth, which may be a measurement indicating a maximum capacity of a wireless communications link to transmit data over a network connection.

In another example, the problem may be based on priority information associated with data routing.

In another example, the problem may be based on priority information associated with data forwarding.

In another example, the problem may be based on priority information associated with data discarding.

In another example, the problem may be based on priority information associated with an uplink throughput, which may indicate a measure of how many units of uplink information a system can process in a given amount of time.

In another example, the problem may be based on priority information associated with a downlink throughput, which may indicate a measure of how many units of downlink information a system can process in a given amount of time.

In another example, the problem may be based on latency information.

As indicated at 730, the UE transmits the QoE measurements to the core network entity, in accordance with the capability information of the UE. For example, the UE may measure the QoE measurements and then transmit the QoE measurements to the core network entity. In one example, the QoE measurements may be based on information associated with processing of one or more downlink signals received at the UE. In another example, the QoE measurements may be based on information associated with processing of one or more uplink signals transmitted by the UE.

In certain aspects, the UE may transmit a first indication to the core network entity based on the capability information of the UE. The first indication may indicate that the one or more values of the QoE measurements are below the threshold due to the core network entity.

In certain aspects, the UE may transmit a second indication to the core network entity. The second indication may indicate one or more actions to be performed by the core network entity based on the one or more values of the QoE measurements being below the threshold.

In one aspect, the UE may send the first indication and the second indication to the core network entity in a same message. In another aspect, the UE may send the first indication and the second indication to the core network entity in different/separate messages at a same time or different times.

In one example, one of the one or more actions may be an update of the QoS policy associated with the UE. In some aspects, the UE may also indicate which features of the QoS policy have to be updated and when.

In another example, one of the one or more actions may be switching of the UPF.

In another example, one of the one or more actions may be an update of the transport network bandwidth. For instance, the UE may determine and indicate an updated value for the transport network bandwidth.

In another example, one of the one or more actions may be an update of the priority information associated with data routing. For instance, the UE may determine and indicate the updated priority information associated with the data routing.

In another example, one of the one or more actions may be an update of the priority information associated with data forwarding. For instance, the UE may determine and indicate the updated priority information associated with the data forwarding.

In another example, one of the one or more actions may be an update of the priority information associated with data discarding. For instance, the UE may determine and indicate the updated priority information associated with the data discarding.

In another example, one of the one or more actions may be an update of the priority information associated with an uplink throughput. For instance, the UE may determine and indicate the updated priority information associated with the uplink throughput.

In another example, one of the one or more actions may be an update of the priority information associated with a downlink throughput. For instance, the UE may determine and indicate the updated priority information associated with the downlink throughput.

In another example, one of the one or more actions may be an update of the latency information. For instance, the UE may determine and indicate the updated priority information associated with the latency information.

In certain aspects, the UE may define a new signaling radio bearer (SRB) for transmission of the QoE measurements to the core network entity. In some aspects, the UE may receive an indication of the new SRB from the core network entity (e.g., when the core network entity may define the new SRB). In some aspects, the UE may receive an indication of the new SRB from the gNB (e.g., when the gNB may define the new SRB).

In certain aspects, the UE may use the new SRB for the transmission of the QoE measurements to the core network entity. For example, the UE may transmit the QoE measurements to the core network entity via the new SRB.

In certain aspects, the UE may use (or reuse) a legacy SRB (e.g., for non-access stratum (NAS) signaling) for transmission of the QoE measurements to the core network entity. For example, the UE may transmit the QoE measurements to the core network entity via an SRB-2.

As indicated at 740, the core network entity determines that the one or more values of the QoE measurements are below the threshold, based on information/message received from the UE.

In certain aspects, the core network entity (e.g., the AMF, a session management function (SMF), or a policy control function (PCF) associated with the core network entity) performs the one or more actions (e.g., for modification of some features associated with a core network), when the one or more values of the QoE measurements are below the threshold, to improve overall QoE. In one aspect, the core network entity may receive an indication of the one or more actions. In another aspect, the core network entity may determine the one or more actions to be performed.

In one example, the core network entity may update a current QoS policy associated with the UE to define a new QoS policy, when the one or more values of the QoE measurements are below the threshold, to improve the QoE. The new QoS policy is different from the current QoS policy.

In another example, the core network entity may switch the UPF, when the one or more values of the QoE measurements are below the threshold, to improve the QoE.

In another example, the core network entity may update a current value of the transport network bandwidth to define a new value of the transport network bandwidth, when the one or more values of the QoE measurements are below the threshold, to improve the QoE. The new value of the transport network bandwidth is different from the current value of the transport network bandwidth.

In another example, the core network entity may update current priority information associated with the data routing to define new priority information associated with the data routing, when the one or more values of the QoE measurements are below the threshold, to improve the QoE. The new priority information associated with the data routing is different from the current priority information associated with the data routing.

In another example, the core network entity may update current priority information associated with the data forwarding to define new priority information associated with the data forwarding, when the one or more values of the QoE measurements are below the threshold, to improve the QoE. The new priority information associated with the data forwarding is different from the current priority information associated with the data forwarding.

In another example, the core network entity may update current priority information associated with the data discarding to define new priority information associated with the data discarding, when the one or more values of the QoE measurements are below the threshold, to improve the QoE. The new priority information associated with the data discarding is different from the current priority information associated with the data discarding.

In another example, the core network entity may update current priority information associated with an uplink throughput to define new priority information associated with the uplink throughput, when the one or more values of the QoE measurements are below the threshold, to improve the QoE. The new priority information associated with the uplink throughput is different from the current priority information associated with the uplink throughput.

In another example, the core network entity may update current priority information associated with a downlink throughput to define new priority information associated with the downlink throughput, when the one or more values of the QoE measurements are below the threshold, to improve the QoE. The new priority information associated with the downlink throughput is different from the current priority information associated with the downlink throughput.

In another example, the core network entity may update current latency information to define new latency information, when the one or more values of the QoE measurements are below the threshold, to improve the QoE. The new latency information is different from the current latency information.

### Example Method for Wireless Communications at a User Equipment (UE)

FIG. 8 shows an example of a method 800 for wireless communications at a wireless node. The wireless node may be a user equipment (UE), such as the UE 104 of FIG. 1 and FIG. 3.

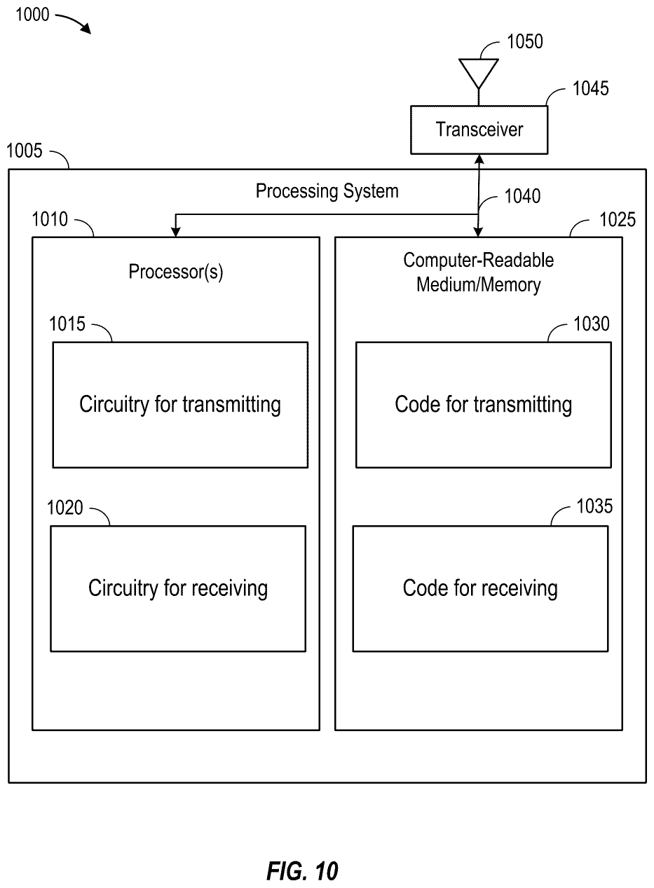

Method 800 begins at 810 with transmitting capability information indicating an ability of the UE to report quality of experience (QoE) measurements associated with the UE to a core network entity. In some cases, the operations of this step refer to, or may be performed by, circuitry for transmitting and/or code for transmitting as described with reference to FIG. 10.

Method 800 then proceeds to 820 with transmitting first QoE measurements associated with the UE to the core network entity, in accordance with the capability information. The first QoE measurements may include values indicating QoE of using one or more services (e.g., video streaming services) at the UE. In some cases, the operations of this step refer to, or may be performed by, circuitry for transmitting and/or code for transmitting as described with reference to FIG. 10.

In certain aspects, the capability information further indicates an ability of the UE to report that one or more values of the first QoE measurements being below a threshold is caused by a source other than a radio access network (RAN) node, and wherein the threshold is defined by the UE or the RAN node.

In certain aspects, the capability information further indicates an ability of the UE to report one or more problems associated with the core network entity that result in one or more values of the first QoE measurements being below a threshold, and wherein the threshold is defined by the UE or a RAN node.

In certain aspects, the one or more problems are associated with at least one of: a quality of service (QOS) policy associated with the UE, a user plane function (UPF), a transport network bandwidth, priority information associated with data routing, priority information associated with data forwarding, priority information associated with data discarding, priority information associated with an uplink throughput, priority information associated with a downlink throughput, or a latency.

In certain aspects, the method 800 further includes transmitting a first indication that one or more values of the first QoE measurements are below a threshold due to the core network entity, and wherein the threshold is defined by the UE or a RAN node. In some cases, the operations of this step refer to, or may be performed by, circuitry for transmitting and/or code for transmitting as described with reference to FIG. 10.

In certain aspects, the method 800 further includes transmitting a second indication of one or more actions to be performed by the core network entity based on the one or more values of the first QoE measurements being below the threshold. In some cases, the operations of this step refer to, or may be performed by, circuitry for transmitting and/or code for transmitting as described with reference to FIG. 10.

In certain aspects, the one or more actions include at least one of: an update of QoS policy associated with the UE, switching of UPF, an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency.

In certain aspects, the method 800 further includes defining a first signaling radio bearer (SRB) for transmission of the QoE measurements associated with the UE to the core network entity.

In certain aspects, the method 800 further includes using a second SRB for transmission of the QoE measurements associated with the UE to the core network entity. The second SRB is different from the first SRB.

In certain aspects, the method 800 further includes receiving a QoE measurement configuration to perform the QoE measurements associated with the core network entity. In some cases, the operations of this step refer to, or may be performed by, circuitry for receiving and/or code for receiving as described with reference to FIG. 10.

In one aspect, the method 800, or any aspect related to it, may be performed by an apparatus, such as a communications device 1000 of FIG. 10, which includes various components operable, configured, or adapted to perform the method 800. The communications device 1000 is described below in further detail.

Note that FIG. 8 is just one example of a method, and other methods including fewer, additional, or alternative steps are possible consistent with this disclosure.

### Example Method for Wireless Communications at a Core Network Entity

FIG. 9 shows an example of a method 900 for wireless communications at a wireless node. The wireless node may be a core network entity, such as the 5GC 190 of FIG. 1, or the BS 102 of FIG. 1 and FIG. 3.

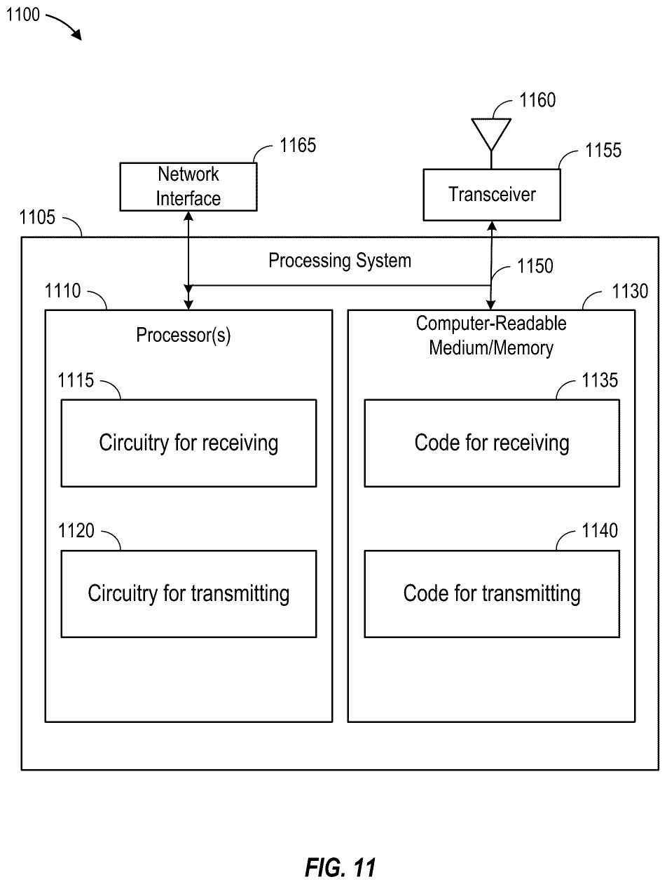

Method 900 begins at step 910 with receiving capability information of a user equipment (UE) indicating an ability of the UE to report quality of experience (QoE) measurements associated with the UE to the core network entity. In some cases, the operations of this step refer to, or may be performed by, circuitry for receiving and/or code for receiving as described with reference to FIG. 11.

Method 900 then proceeds to step 920 with receiving first QoE measurements associated with the UE, in accordance with the capability information of the UE. The first QoE measurements may include values indicating QoE of using one or more services (e.g., video streaming services) at the UE. In some cases, the operations of this step refer to, or may be performed by, circuitry for receiving and/or code for receiving as described with reference to FIG. 11.

In certain aspects, the method 900 further includes determining that one or more values of the first QoE measurements are below a threshold, wherein the threshold is defined by the UE or a radio access network (RAN) node; and performing one or more actions including at least one of: an update of quality of service (QOS) policy associated with the UE, switching of a user plane function (UPF), an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency, in accordance with the determination.

In certain aspects, the capability information further indicates an ability of the UE to report that one or more values of the first QoE measurements being below a threshold is caused by a source other than a RAN node, and wherein the threshold is defined by the UE or the RAN node.

In certain aspects, the capability information further indicates an ability of the UE to report one or more problems associated with the core network entity that result in one or more values of the first QoE measurements being below a threshold, and wherein the threshold is defined by the UE or a RAN node.

In certain aspects, the one or more problems are associated with at least one of: a QoS policy associated with the UE, UPF, a transport network bandwidth, priority information associated with data routing, priority information associated with data forwarding, priority information associated with data discarding, priority information associated with an uplink throughput, priority information associated with a downlink throughput, or a latency.

In certain aspects, the method 900 further includes receiving a first indication that one or more values of the first QoE measurements are below a threshold due to the core network entity, and wherein the threshold is defined by the UE or a radio access network (RAN). In some cases, the operations of this step refer to, or may be performed by, circuitry for receiving and/or code for receiving as described with reference to FIG. 11.

In certain aspects, the method 900 further includes receiving a second indication of one or more actions to be performed by the core network entity based on the one or more values of the first QoE measurements being below the threshold. In some cases, the operations of this step refer to, or may be performed by, circuitry for receiving and/or code for receiving as described with reference to FIG. 11.

In certain aspects, the one or more actions include at least one of: an update of QoS policy associated with the UE, switching of UPF, an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency.

In certain aspects, the method 900 further includes receiving the QoE measurements via a first signaling radio bearer (SRB). In some cases, the operations of this step refer to, or may be performed by, circuitry for receiving and/or code for receiving as described with reference to FIG. 11.

In certain aspects, the method 900 further includes receiving the QoE measurements via a second SRB. In some cases, the operations of this step refer to, or may be performed by, circuitry for receiving and/or code for receiving as described with reference to FIG. 11. The second SRB is different from the first SRB.

In certain aspects, the method 900 further includes transmitting a QoE measurement configuration to perform the QoE measurements associated with core network entity. In some cases, the operations of this step refer to, or may be performed by, circuitry for transmitting and/or code for transmitting as described with reference to FIG. 11.

In one aspect, the method 900, or any aspect related to it, may be performed by an apparatus, such as a communications device 1100 of FIG. 11, which includes various components operable, configured, or adapted to perform the method 900. The communications device 1100 is described below in further detail.

Note that FIG. 9 is just one example of a method, and other methods including fewer, additional, or alternative steps are possible consistent with this disclosure.

### Example Communications Devices

FIG. 10 depicts aspects of an example communications device 1000. In some aspects, the communications device 1000 may be a user equipment (UE), such as UE 104 described above with respect to FIG. 1 and FIG. 3.

The communications device 1000 includes a processing system 1005 coupled to a transceiver 1045 (e.g., a transmitter and/or a receiver). The transceiver 1045 is configured to transmit and receive signals for the communications device 1000 via an antenna 1050, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, cause the one or more processors 1010 to perform the method 800 described with respect to FIG. 8, and/or any aspect related to it. Note that reference to a processor performing a function of communications device 1000 may include the one or more processors 1010 performing that function of communications device 1000.

In the depicted example, computer-readable medium/memory 1025 stores code (e.g., executable instructions), such as code for transmitting (or outputting) 1030 and code for receiving (or obtaining) 1035. Processing of the code for transmitting 1030 and the code for receiving 1035 may cause the communications device 1000 to perform the method 800 described with respect to FIG. 8, and/or any aspect related to it.

The one or more processors 1010 include circuitry configured to implement (e.g., execute) the code stored in the computer-readable medium/memory 1025, including circuitry such as circuitry for transmitting (or outputting) 1015 and circuitry for receiving (or obtaining) 1020. Processing with the circuitry for transmitting 1015 and the circuitry for receiving 1020 may cause the communications device 1000 to perform the method 800 described with respect to FIG. 8, and/or any aspect related to it.

Various components of the communications device 1000 may provide means for performing the method 800 described with respect to FIG. 8, and/or any aspect related to it. For example, means for transmitting, sending or outputting (e.g., for transmission) may include transceivers 354 and/or antenna(s) 352 of the UE 104 illustrated in FIG. 3 and/or the code for transmitting 1030, the circuitry for transmitting 1015, the transceiver 1045 and the antenna 1050 of the communications device 1000 in FIG. 10. Means for receiving or obtaining may include transceivers 354 and/or antenna(s) 352 of the UE 104 illustrated in FIG. 3 and/or the code for receiving 1035, the circuitry for receiving 1020, the transceiver 1045 and the antenna 1050 of the communications device 1000 in FIG. 10.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 10 is an example, and many other examples and configurations of communication device 1000 are possible.

FIG. 11 depicts aspects of an example communications device 1100. In some aspects, communications device 1100 may be a core network entity, such as the 5GC 190 of FIG. 1, or the BS 102 of FIG. 1 and FIG. 3.

The communications device 1100 includes a processing system 1105 coupled to a transceiver 1155 (e.g., a transmitter and/or a receiver) and/or a network interface 1165. The transceiver 1155 is configured to transmit and receive signals for the communications device 1100 via an antenna 1160, such as the various signals as described herein. The network interface 1165 is configured to obtain and send signals for the communications device 1100 via communication link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it. Note that reference to a processor of communications device 1100 performing a function may include the one or more processors 1110 of communications device 1100 performing that function.

In the depicted example, the computer-readable medium/memory 1130 stores code (e.g., executable instructions), such as code for receiving (or obtaining) 1135 and code for transmitting (or outputting) 1140. Processing of the code for receiving 1135 and the code for transmitting 1140 may cause the communications device 1100 to perform the method 900 described with respect to FIG. 9, or any aspect related to it.

The one or more processors 1110 include circuitry configured to implement (e.g., execute) the code stored in the computer-readable medium/memory 1130, including circuitry such as circuitry for receiving (or obtaining) 1115 and circuitry for transmitting (or outputting) 1120. Processing with the circuitry for receiving 1115 and the circuitry for transmitting 1120 may cause the communications device 1100 to perform the method 900 described with respect to FIG. 9, or any aspect related to it.

Various components of the communications device 1100 may provide means for performing the method 900 described with respect to FIG. 9, or any aspect related to it. Means for transmitting, sending or outputting for transmission may include transceivers 332 and/or antenna(s) 334 of the BS 102 illustrated in FIG. 3 and/or the circuitry for transmitting 1120, the code for transmitting 1140, the transceiver 1155 and the antenna 1160 of the communications device 1100 in FIG. 11. Means for receiving or obtaining may include transceivers 332 and/or antenna(s) 334 of the BS 102 illustrated in FIG. 3 and/or the circuitry for receiving 1115, the code for receiving 1135, the transceiver 1155 and the antenna 1160 of the communications device 1100 in FIG. 11.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 11 is an example, and many other examples and configurations of communication device 1100 are possible.

### EXAMPLE CLAUSES

Implementation examples are described in the following numbered clauses:
Clause 1: A method for wireless communications at a user equipment (UE), comprising: transmitting capability information indicating an ability of the UE to report quality of experience (QoE) measurements associated with the UE to a core network entity; and transmitting first QoE measurements associated with the UE to the core network entity, in accordance with the capability information.
Clause 2: The method of clause 1, wherein the capability information further indicates an ability of the UE to report that one or more values of the first QoE measurements being below a threshold is caused by a source other than a radio access network (RAN) node, and wherein the threshold is defined by the UE or the RAN node.
Clause 3: The method of any one of clauses 1-2, wherein the capability information further indicates an ability of the UE to report one or more problems associated with the core network entity that result in one or more values of the first QoE measurements being below a threshold, and wherein the threshold is defined by the UE or a radio access network (RAN) node.
Clause 4: The method of clause 3, wherein the one or more problems are associated with at least one of: a quality of service (QOS) policy associated with the UE, a user plane function (UPF), a transport network bandwidth, priority information associated with data routing, priority information associated with data forwarding, priority information associated with data discarding, priority information associated with an uplink throughput, priority information associated with a downlink throughput, or a latency.
Clause 5: The method of clause 3, further comprising transmitting a first indication that the one or more values of the first QoE measurements are below the threshold due to the core network entity, and wherein the threshold is defined by the UE or a radio access network (RAN) node.
Clause 6: The method of clause 5, further comprising transmitting a second indication of one or more actions to be performed by the core network entity based on the one or more values of the first QoE measurements being below the threshold.
Clause 7: The method of clause 6, wherein the one or more actions comprise at least one of: an update of quality of service (QOS) policy associated with the UE, switching of a user plane function (UPF), an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency.
Clause 8: The method of any one of clauses 1-7, further comprising using a first signaling radio bearer (SRB) for transmission of the QoE measurements associated with the UE to the core network entity.
Clause 9: The method of clause 8, further comprising using a second SRB for transmission of the first QoE measurements associated with the UE to the core network entity, wherein the second SRB is different from the first SRB.
Clause 10: The method of any one of clauses 1-9, further comprising receiving a QoE measurement configuration to perform the QoE measurements associated with the core network entity.
Clause 11: A method for wireless communications at a core network entity, comprising: receiving capability information of a user equipment (UE) indicating an ability of the UE to report quality of experience (QoE) measurements associated with the UE to the core network entity; and receiving first QoE measurements associated with the UE, in accordance with the capability information of the UE.
Clause 12: The method of clause 11, further comprising: determining that one or more values of the first QoE measurements are below a threshold, wherein the threshold is defined by the UE or a radio access network (RAN) node; and performing one or more actions comprising at least one of: an update of quality of service (QOS) policy associated with the UE, switching of a user plane function (UPF), an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency, in accordance with the determination.
Clause 13: The method of any one of clauses 11-12, wherein the capability information further indicates an ability of the UE to report that one or more values of the first QoE measurements being below a threshold is caused by a source other than a radio access network (RAN) node, and wherein the threshold is defined by the UE or the RAN node.
Clause 14: The method of any one of clauses 11-13, wherein the capability information further indicates an ability of the UE to report one or more problems associated with the core network entity that result in one or more values of the first QoE measurements being below a threshold, and wherein the threshold is defined by the UE or a radio access network (RAN) node.
Clause 15: The method of any one of clauses 11-14, wherein the one or more problems are associated with at least one of: a quality of service (QOS) policy associated with the UE, a user plane function (UPF), a transport network bandwidth, priority information associated with data routing, priority information associated with data forwarding, priority information associated with data discarding, priority information associated with an uplink throughput, priority information associated with a downlink throughput, or a latency.
Clause 16: The method of clause 14, further comprising receiving a first indication that the one or more values of the first QoE measurements are below the threshold due to the core network entity, and wherein the threshold is defined by the UE or a radio access network (RAN) node.
Clause 17: The method of clause 16, further comprising receiving a second indication of one or more actions to be performed by the core network entity based on the one or more values of the first QoE measurements being below the threshold.
Clause 18: The method of clause 17, wherein the one or more actions comprise at least one of: an update of quality of service (QOS) policy associated with the UE, switching of a user plane function (UPF), an update of transport network bandwidth, an update of priority information associated with data routing, an update of priority information associated with data forwarding, an update of priority information associated with data discarding, an update of priority information associated with an uplink throughput, an update of priority information associated with a downlink throughput, or an update of a latency.
Clause 19: The method of any one of clauses 11-18, wherein the receiving of the QoE measurements comprises receiving the first QoE measurements via a first signaling radio bearer (SRB).
Clause 20: The method of any one of clauses 11-19, wherein the receiving of the QoE measurements comprises receiving the first QoE measurements via a second SRB, wherein the second SRB is different from the first SRB.
Clause 21: The method of any one of clauses 11-20, further comprising transmitting a QoE measurement configuration to perform the QoE measurements associated with core network entity.
Clause 22: An apparatus, comprising: a memory comprising instructions; and one or more processors configured, individually or in any combination, to execute the instructions and cause the apparatus to perform a method in accordance with any one of Clauses 1-21.
Clause 23: An apparatus, comprising means for performing a method in accordance with any one of Clauses 1-21.
Clause 24: A non-transitory computer-readable medium comprising executable instructions that, when executed by one or more processors of an apparatus, cause the apparatus to perform a method in accordance with any one of Clauses 1-21.
Clause 25: A computer program product embodied on a computer-readable storage medium comprising code for performing a method in accordance with any one of Clauses 1-21.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
one or more memories comprising instructions; and
one or more processors, individually or collectively, configured to execute the instructions and cause the apparatus to:
transmit capability information indicating an ability of the UE to report quality of experience (QoE) measurements associated with the UE to a core network entity; and
transmit first QoE measurements associated with the UE to the core network entity, in accordance with the capability information.

2. The apparatus of claim 1, wherein:
the capability information further indicates an ability of the UE to report that one or more values of the first QoE measurements being below a threshold is caused by a source other than a radio access network (RAN) node, and
the threshold is defined by the UE or the RAN node.

3. The apparatus of claim 1, wherein:
the capability information further indicates an ability of the UE to report one or more problems associated with the core network entity that result in one or more values of the first QoE measurements being below a threshold, and
the threshold is defined by the UE or a radio access network (RAN) node.

4. The apparatus of claim 3, wherein the one or more problems are associated with at least one of:
a quality of service (QOS) policy associated with the UE,
a user plane function (UPF), a transport network bandwidth,
priority information associated with data routing,
priority information associated with data forwarding,
priority information associated with data discarding,
priority information associated with an uplink throughput,
priority information associated with a downlink throughput, or
a latency.

5. The apparatus of claim 3, wherein:
the one or more processors, individually or collectively, are configured to execute the instructions and cause the apparatus to transmit a first indication that the one or more values of the first QoE measurements are below the threshold due to the core network entity, and
the threshold is defined by the UE or a radio access network (RAN) node.

6. The apparatus of claim 5, wherein the one or more processors, individually or collectively, are configured to execute the instructions and cause the apparatus to transmit a second indication of one or more actions to be performed by the core network entity based on the one or more values of the first QoE measurements being below the threshold.

7. The apparatus of claim 6, wherein the one or more actions comprise at least one of:
an update of quality of service (QOS) policy associated with the UE,
switching of a user plane function (UPF),
an update of transport network bandwidth,
an update of priority information associated with data routing,
an update of priority information associated with data forwarding,
an update of priority information associated with data discarding,
an update of priority information associated with an uplink throughput,
an update of priority information associated with a downlink throughput, or
an update of latency information.

8. The apparatus of claim 1, wherein the one or more processors, individually or collectively, are configured to execute the instructions and cause the apparatus to use a first signaling radio bearer (SRB) for transmission of the first QoE measurements associated with the UE to the core network entity.

9. The apparatus of claim 8, wherein the one or more processors, individually or collectively, are configured to execute the instructions and cause the apparatus to use a second SRB for transmission of the first QoE measurements associated with the UE to the core network entity, wherein the second SRB is different from the first SRB.

10. The apparatus of claim 1, wherein the one or more processors, individually or collectively, are configured to execute the instructions and cause the apparatus to receive a QoE measurement configuration to perform the QoE measurements associated with the core network entity.

11. An apparatus for wireless communications at a core network entity, comprising:
one or more memories comprising instructions; and
one or more processors, individually or collectively, configured to execute the instructions and cause the apparatus to:
receive capability information of a user equipment (UE) indicating an ability of the UE to report quality of experience (QoE) measurements associated with the UE to the core network entity; and
receive first QoE measurements associated with the UE, in accordance with the capability information of the UE.

12. The apparatus of claim 11, wherein the one or more processors, individually or collectively, are configured to execute the instructions and cause the apparatus to:
determine that one or more values of the first QoE measurements are below a threshold, wherein the threshold is defined by the UE or a radio access network (RAN) node; and
perform one or more actions comprising at least one of:
an update of quality of service (QOS) policy associated with the UE,
switching of a user plane function (UPF),
an update of transport network bandwidth,
an update of priority information associated with data routing,
an update of priority information associated with data forwarding,
an update of priority information associated with data discarding,
an update of priority information associated with an uplink throughput,
an update of priority information associated with a downlink throughput, or
an update of latency information, in accordance with the determination.

13. The apparatus of claim 11, wherein:
the capability information further indicates an ability of the UE to report that one or more values of the first QoE measurements being below a threshold is caused by a source other than a radio access network (RAN) node, and
the threshold is defined by the UE or the RAN node.

14. The apparatus of claim 11, wherein:
the capability information further indicates an ability of the UE to report one or more problems associated with the core network entity that result in one or more values of the first QoE measurements being below a threshold, and
the threshold is defined by the UE or a radio access network (RAN) node.

15. The apparatus of claim 14, wherein the one or more problems are associated with at least one of:
a quality of service (QOS) policy associated with the UE,
a user plane function (UPF),
a transport network bandwidth,
priority information associated with data routing,
priority information associated with data forwarding,
priority information associated with data discarding,
priority information associated with an uplink throughput,
priority information associated with a downlink throughput, or
a latency.

16. The apparatus of claim 14, wherein:
the one or more processors, individually or collectively, are configured to execute the instructions and cause the apparatus to receive a first indication that the one or more values of the first QoE measurements are below the threshold due to the core network entity, and
the threshold is defined by the UE or a radio access network (RAN) node.

17. The apparatus of claim 16, wherein the one or more processors, individually or collectively, are configured to execute the instructions and cause the apparatus to receive a second indication of one or more actions to be performed by the core network entity based on the one or more values of the first QoE measurements being below the threshold.

18. The apparatus of claim 17, wherein the one or more actions comprise at least one of:
an update of quality of service (QOS) policy associated with the UE,
switching of a user plane function (UPF),
an update of transport network bandwidth,
an update of priority information associated with data routing,
an update of priority information associated with data forwarding,
an update of priority information associated with data discarding,
an update of priority information associated with an uplink throughput,
an update of priority information associated with a downlink throughput, or
an update of latency information.

19. The apparatus of claim 11, wherein the one or more processors, individually or collectively, are configured to execute the instructions and cause the apparatus to receive the first QoE measurements via a first signaling radio bearer (SRB).

20. The apparatus of claim 19, wherein the one or more processors, individually or collectively, are configured to execute the instructions and cause the apparatus to receive the first QoE measurements via a second SRB-2, wherein the second SRB is different from the first SRB.

21. The apparatus of claim 11, wherein the one or more processors, individually or collectively, are configured to execute the instructions and cause the apparatus to transmit a QoE measurement configuration to perform the QoE measurements associated with core network entity.

22. A method for wireless communications at a user equipment (UE), comprising:
transmitting capability information indicating an ability of the UE to report quality of experience (QoE) measurements associated with the UE to a core network entity; and
transmitting first QoE measurements associated with the UE to the core network entity, in accordance with the capability information.

23. The method of claim 22, wherein:
the capability information further indicates an ability of the UE to report that one or more values of the first QoE measurements being below a threshold is caused by a source other than a radio access network (RAN) node, and
the threshold is defined by the UE or the RAN node.

24. The method of claim 22, wherein:
the capability information further indicates an ability of the UE to report one or more problems associated with the core network entity that result in one or more values of the first QoE measurements being below a threshold, and
the threshold is defined by the UE or a radio access network (RAN) node.

25. The method of claim 24, wherein the one or more problems are associated with at least one of:
a quality of service (QOS) policy associated with the UE,
a user plane function (UPF),
a transport network bandwidth,
priority information associated with data routing,
priority information associated with data forwarding,
priority information associated with data discarding,
priority information associated with an uplink throughput,
priority information associated with a downlink throughput, or
a latency.

26. The method of claim 22, further comprising transmitting a first indication that one or more values of the first QoE measurements are below a threshold due to the core network entity, and wherein the threshold is defined by the UE or a radio access network (RAN) node.

27. A method for wireless communications at a core network entity, comprising:
receiving capability information of a user equipment (UE) indicating an ability of the UE to report quality of experience (QoE) measurements associated with the UE to the core network entity; and
receiving first QoE measurements associated with the UE, in accordance with the capability information of the UE.

28. The method of claim 27, further comprising:
determining that one or more values of the first QoE measurements are below a threshold, wherein the threshold is defined by the UE or a radio access network (RAN) node; and
performing one or more actions comprising at least one of:
an update of quality of service (QOS) policy associated with the UE,
switching of a user plane function (UPF),
an update of transport network bandwidth,
an update of priority information associated with data routing,
an update of priority information associated with data forwarding,
an update of priority information associated with data discarding,
an update of priority information associated with an uplink throughput,
an update of priority information associated with a downlink throughput,
or
an update of latency information, in accordance with the determination.

29. The method of claim 27, wherein:
the capability information further indicates an ability of the UE to report that one or more values of the first QoE measurements being below a threshold is caused by a source other than a radio access network (RAN) node, and
the threshold is defined by the UE or the RAN node.

30. The method of claim 27, wherein:
the capability information further indicates an ability of the UE to report one or more problems associated with the core network entity that result in one or more values of the first QoE measurements being below a threshold, and
the threshold is defined by the UE or a radio access network (RAN) node.
